(19) United States
(12) Patent Application Publication
(10) Pub. No.: US 2022/0308840 A1
(43) Pub. Date: Sep. 29, 2022

(54) RECIPROCAL CALCULATING METHOD AND RECIPROCAL CALCULATING APPARATUS

(71) Applicant: FUJI ELECTRIC CO., LTD., Kanagawa (JP)

(72) Inventor: Kenji TAKATSUKASA, Tokyo (JP)

(21) Appl. No.: 17/652,170

(22) Filed: Feb. 23, 2022

(30) Foreign Application Priority Data
Mar. 22, 2021 (JP) 2021-047134

(51) Int. Cl. G06F 7/72; H04L 9/06

(52) U.S. Cl. CPC G06F 7/722; H04L 9/0631

(57) ABSTRACT

With respect to a method for execution by an information processing apparatus, the method includes calculating a reciprocal in multiplication on a residue field modulo a power of 2.

### CROSS-REFERENCE TO RELATED APPLICATION

This application is based upon and claims priority to Japanese Patent Application No. 2021-047134, filed on Mar. 22, 2021, the entire contents of which are incorporated herein by reference.

### BACKGROUND OF THE INVENTION

### 1. Field of the Invention

The present disclosure relates to a reciprocal calculating method, a reciprocal calculating apparatus, and a non-transitory computer-readable recording medium having stored a reciprocal calculating program.

### 2. Description of the Related Art

Conventionally, reciprocal computation is used in various computer algorithms. For example, Patent Document 1 describes an algorithm of calculating a reciprocal by repeatedly updating five registers in parallel.

For example, white-box cryptography combines an encryption key value and an operation defined by an algorithm to generate a look-up table. At this time, a transform and an inverse transform are interposed between successive operations at the input and the output, and the transform is combined with a look-up table of the previous operation and the inverse transform is combined with a look-up table of the subsequent operation, thereby obfuscating the cryptographic key. One of operations of the transform and the inverse transform that are applicable to this obscuration is multiplication and reciprocal multiplication.

### RELATED-ART DOCUMENTS

### Patent Document

[Patent Document 1] Japanese Laid-Open Patent Application Publication No. 2002-175180

### SUMMARY OF THE INVENTION

According to one aspect of an embodiment, with respect to a method for execution by an information processing apparatus, the method includes calculating a reciprocal in multiplication on a residue field modulo a power of 2.

### BRIEF DESCRIPTION OF THE DRAWINGS

FIG. 1 is a flowchart of a process of calculating a reciprocal according to an embodiment of the present disclosure;

FIG. 2 illustrates an example of reciprocal calculation according to the embodiment of the present disclosure;

FIG. 3 is a flowchart of a process of calculating a reciprocal according to another embodiment of the present disclosure;

FIG. 4 illustrates an example of an application to white-box AES according to the embodiment of the disclosure; and

FIG. 5 is a block diagram illustrating an example of a hardware configuration of an information processing apparatus according to the embodiment of the present disclosure.

### DETAILED DESCRIPTION OF THE EMBODIMENTS

In a case of embedded devices having low computing power, which are seen in the recent popularization of Internet of Things (IoT), the load of calculating reciprocals for multiplied values is large. Furthermore, there is a problem in calculation that the number of bits of a multiplied value is greater than the number of bits of an original value that is not multiplied, in multiplication on a residue field modulo a prime number, such as RSA (Rivest, Shamir, Adleman) cryptography.

Thus, it is desirable to improve the performance to calculate a reciprocal decimal number in binary data.

According to an embodiment of the present disclosure, the performance to calculate a reciprocal decimal number in binary data can be improved.

In the following, an embodiment of the present disclosure will be described with reference to the drawings. Here, an information processing apparatus 1 performs a process of calculating a reciprocal.

<Outline>

In the present disclosure, in order to satisfy a condition that a reciprocal is present on a residue field modulo a power of 2, a multiplying value is limited to an odd number. Whether a value obtained by multiplying the odd number with a power of 2, such as 1, 2, 4, . . . , is added or is not added is selected such that a bit at the lower end of the added value is 0 (zero), and a reciprocal is defined as a bit string of 1 and 0, which respectively indicate addition and no-addition.

Because the multiplication on a residue field modulo a power of 2 that limits the multiplying value to an odd number satisfies the following, a value obtained by multiplying values can be expressed by the same bit number as the value to be multiplied.

x×a=y

y×b=x (where x, y, a, and b are all n bits and a and b are odd numbers)

An n-bit value x is mapped to an n-bit value y having the same bit number as the original value by multiplication with an n-bit odd number a. The reciprocal b of the n-bit odd number a, which is multiplied, is also n-bits, and the multiplied value y is further multiplied with the reciprocal b to convert back to the original n-bit value x. The calculation amount of calculating the reciprocal of the multiplied value is O(n), which is small (the calculation amount of the Euclidean Algorithm is O(Log(2ⁿ)²)). Even if 128-bit data commonly used in block cryptography is used, the reciprocal can be calculated with a small calculation load even in embedded equipment.

<Method>

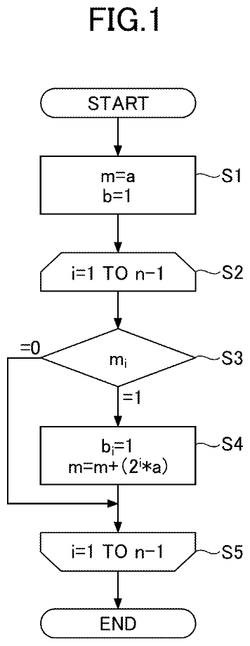

FIG. 1 is a flowchart of a process of calculating a reciprocal according to an embodiment of the present invention.

Here, a product of the value a and the reciprocal b is m, a and b are n-bit odd numbers (a and b are odd numbers for the presence of a reciprocal on a residue field modulo a power of 2).

a*a⁻¹ mod 2ⁿ=1(=m)

b=a⁻¹=2⁰b₀+2¹b₁+2²b₂+ . . . (b is represented in a binary number)

b₀=1 (fixed (b₀=1 because b is an odd number))

m=a*b=a*b₀+2*a*b₁+4*a*b₂+8*a*b₃ . . . .

Because the least significant bit is 0 (zero) with respect to the coefficients other than b₀ (the coefficients of b₁ “2*a”, the coefficients of b₂ “4*a”, the coefficients of b₃ “8*a”, and . . . ), m₀ is independent of values other than b0. That is, a₀=b₀=m₀=1 (fixed). When b₀ is fixed, the lower 2 bits of the coefficients other than b₀ and b₁ are 0 (zero), and thus b₁ for m₁=0 can be uniquely calculated. Therefore, when b₀ to b₁ is fixed, bᵢ₊₁ for mᵢ₊₁=0 can be uniquely calculated.

The information processing apparatus 1 determines b from the lower bit of b such that m finally becomes “1d . . . d0 . . . 01” and the lower n bits are zero except the lowest bit. Here, d may be any value (0 or 1).

In step 1 (S1), the information processing apparatus 1 sets m=a and b₀=1.

In step 2 (S2) to step 5 (S5), the information processing apparatus 1 sequentially updates m, as follows, from i=1 to n−1 with respect to mᵢ to determine b.

If mᵢ=0, bᵢ=0

If mᵢ=1, bᵢ=1 and m=m+2ⁱ*a

Here, because a is an odd number, m₀=1.

For example, when m₁=0, it is not necessary to add a value to make m₁ equal to 0, and b₁=0 can be determined. When m₁=1, it is necessary to add a value to make m₁ equal to 0 (a value obtained by multiplying a by two), and b₁=1 can be determined.

### Calculation Example

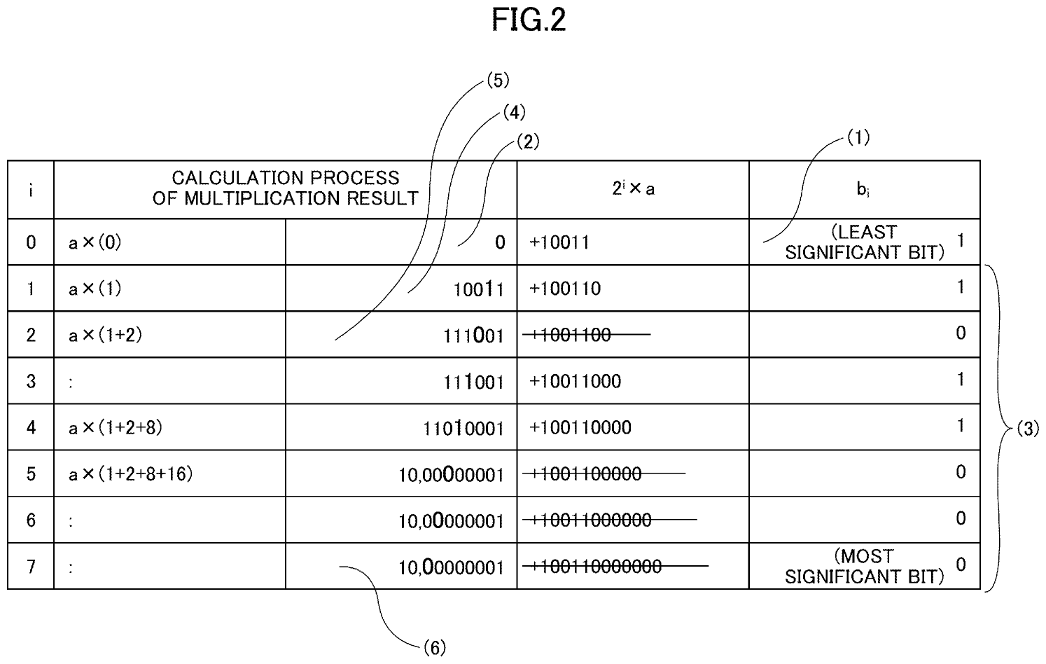

FIG. 2 is an example of calculating a reciprocal according to the embodiment of the invention.

FIG. 2 illustrates an example of 19 (00010011)×27 (00011011)=1 mod 256 (8-bit data), a=19, b=27=a⁻¹. Respective rows of FIG. 2 indicate a process of calculating a multiplication result, 2ⁱ×a, bᵢ, from i=0 to 7. Because the high order bit of the reciprocal b does not affect the low order bit of the multiplication result, the low order bit of the reciprocal is determined such that the final multiplication result is 1.

[When i=0]

In (1) of FIG. 2, bᵢ (the least significant) is fixed to 1. In (2) of FIG. 2, in order to obtain 1 as the result of multiplication, it is necessary that the least significant bit of the reciprocal is 1. Therefore, a×1 is added.

The respective values in (3) of FIG. 2 match the i^{th} bit (which is in bold) of the calculation process of the multiplication result.

[When i=1]

In (4) of FIG. 2, 1 is selected as the first bit of the reciprocal such that the first bit of the multiplication result becomes 0 (zero). Therefore, a×2 is added.

[When i=2]

In (5) of FIG. 2, because the second bit is already 0 (zero), 0 is selected as the second bit of the reciprocal. Therefore, a×4 is not added.

The procedure is similarly performed in the following.

[When i=3]

1 is selected as the third bit of the reciprocal such that the third bit of the multiplication result becomes 0 (zero). Therefore, a×8 is added.

[When i=4]

1 is selected as the fourth bit of the reciprocal such that the fourth bit of the multiplication result becomes 0 (zero). Therefore, a×16 is added.

[When i=5]

Because the fifth bit is already 0 (zero), 0 is selected as the fifth bit of the reciprocal. Therefore, a×32 is not added.

[When i=6]

Because the sixth bit is already 0 (zero), 0 is selected as the sixth bit of the reciprocal. Therefore, a×64 is not added.

[When i=7]

Since the seventh bit is already 0 (zero), 0 is selected as the seventh bit of the reciprocal. Therefore, a×128 is not added. In (6) of FIG. 2, the number of the lower 8 bits in decimal is 1.

<Operation in Register>

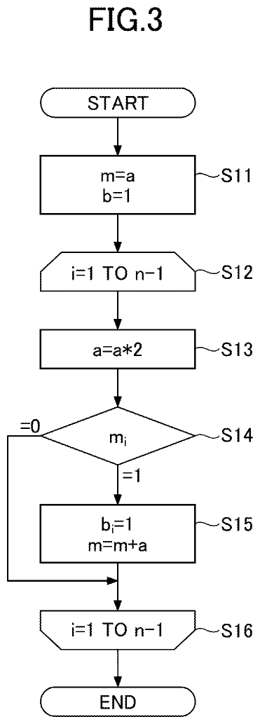

FIG. 3 is a flowchart of a process for calculating a reciprocal according to another embodiment of the present disclosure. Here, in FIG. 1, a form in which an i-power of 2 is added is used to describe the concept of the present disclosure. However, in FIG. 3, on the assumption of actual processing, a form, in which a process of calculating a power of 2 is performed when required and a memory for storing the calculated power of 2 is reduced, is used.

As in FIG. 1, a product of the value a and the reciprocal b is m. Here, a and b are odd numbers. FIG. 3 illustrates a case where a register is 32 bits and the values (a, b, and m) are 128 bits. In FIG. 3, each of a, b, and m is treated as four 32-bit arrays.

a=a[3] (=a127, a126, . . . , a96), a[2] (=a95, . . . , a64), a[1] (=a63, . . . , a32), a[0] (=a31, . . . , a0). Here, b and m are similarly defined.

In step 11 (S11), the information processing apparatus 1 sets m=a and b₀=1.

In steps 12 (S12) to 16 (S16), the information processing apparatus 1 determines b while sequentially updating a and m, as follows, from i=1 to i=n−1 with respect to mᵢ.

a=a×2

When mᵢ=0, bᵢ=0
When mᵢ=1, bᵢ=1, m=m+a
Here, because the initial value of a is an odd number, m₀=1.

With respect to a, which is multiplied by a power of 2 and added, a multiplied result of a is added to m by updating to a value obtained by multiplying 2 each time in the iteration of i.

In step 13 (S13), the following steps are performed.

a=a*2:

a[3]=a[3]<<1 OR a[2]>>31
a[2]=a[2]<<1 OR a[1]>>31
a[1]=a[1]<<1 OR a[0]>>31
a[0]=a[0]<<1

In step 15 (S15), a carry flag is used for an overflow at the time of adding in a register.

m=m+a:

Cf=0

the following is repeated from i=0 to 3.

Cfn=(m[i]>>1+a[i]>>1+(m[i] AND a[i] AND 1))>>31

m[i]+=a[i]+cf

Cf=cfn

<Proof of Inverse Transform>

Here, the proof of the inverse transform will be described.

The following description proves that a value a is multiplied with an arbitrary value x of n bits, and a reciprocal b of the value a is further multiplied with the result of multiplication to convert back to the value x.

Assumptions:

a*b=2ⁿ*D0+1

A remainder when a value obtained by multiplying the reciprocal b with the value a is divided by a power of 2 is 1 (D is a coefficient that disappears in the modulo operation).

x*a=2ⁿ*D1+y

A remainder when a value obtained by multiplying the value a with the value x is divided by a power of 2 is y.

y*b=2ⁿ*D2+z

A remainder when a value obtained by multiplying the reciprocal b with the value y is divided by a power of 2 is z (=x).

Calculation Process Comparison:

$${x}^{★} ( {a}^{★} b ) = {2}^{n ★} D {0}^{★} x + x$$

$$\begin{matrix}{( {x}^{★} a )}^{★} b = {2}^{n ★} D {1}^{★} b + {y}^{★} b \\ = {2}^{n ★} D {1}^{★} b + {2}^{n ★} D {2}^{★} + z \\ = {2}^{n ★} ( D {1}^{★} b + D 2 ) + z\end{matrix}$$

A value obtained by multiplying (a*b) with x is equal to a value obtained by multiplying b with (x*a). That is, x=z.

((x*a)mod 2ⁿ)*b=y*b=2ⁿ*D2+z

Even after storing (x*a) in an n-bit variable (the modulo operation of the power of 2), the remainder calculated by performing the modulo operation of the power of 2 on a value obtained by multiplying the reciprocal number b is z.

CONCLUSION: The relationship between multiplication and reciprocal multiplication is established even if an overflow occurs in the calculation process.

<Application to the White-Box AES>

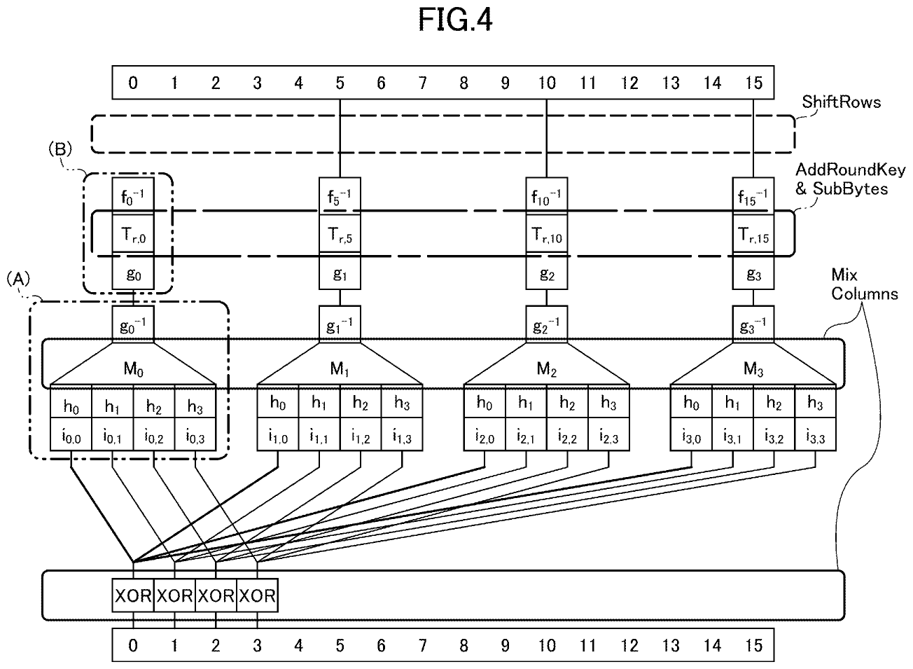

FIG. 4 is an example application to the white-box advanced encryption standard (AES) according to the embodiment of the present invention.

As illustrated in FIG. 4, the present disclosure can be applied to a transform g and an inverse transform g⁻¹ of the white-box AES.

(A) in FIG. 4 is a lookup table in which MixColumns processing is performed on a value obtained by multiplying the reciprocal number g⁻¹ (an obfuscation component) with the input value to combine an obfuscation component that is paired with the next operation.

(B) in FIG. 4 is a lookup table that outputs a value obtained by multiplying a multiplying value g (an obfuscation component) after AddRoundKey and SubBytes processing is performed.

### Effect

As described, in a conventional method, when there is no effective reciprocal calculation means, the reciprocal is obtained by a full search. However, in the present disclosure, the reciprocal can be calculated quickly on a residue field modulo a power of 2. Additionally, the present disclosure is applicable to cryptographic operations, and in n-bit block data, data, obtained after an operation having the n−1 bit data amount (a combination of the above value a) is performed, is n bits, so that the number of bits does not increase.

<Hardware Configuration>

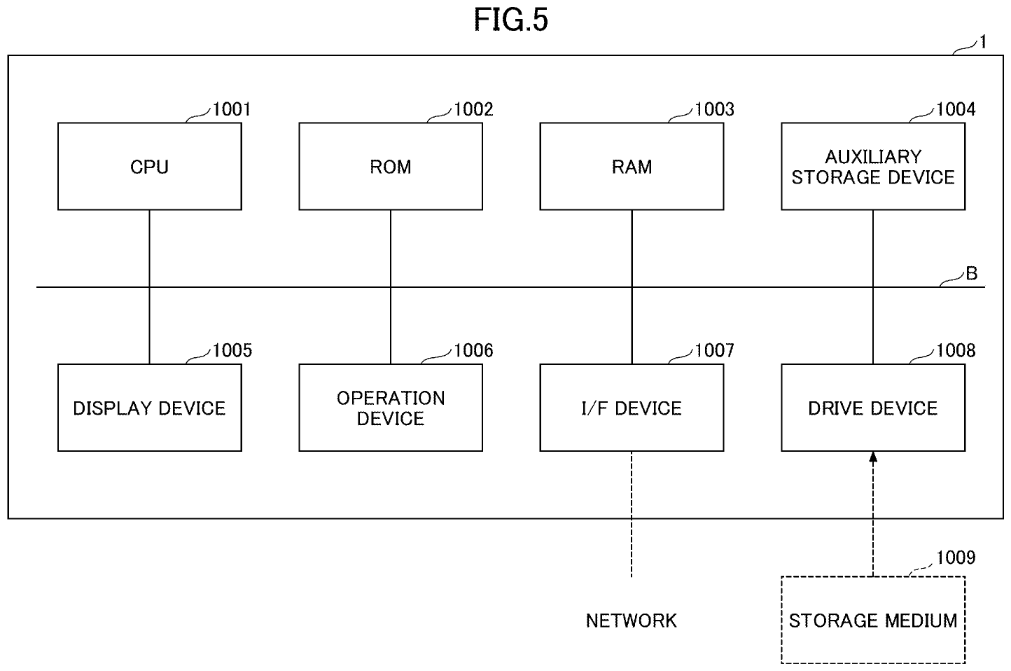

FIG. 5 is a block diagram illustrating an example of a hardware configuration of the information processing apparatus 1 according to the embodiment of the present disclosure. The information processing apparatus 1 includes a central processing unit (CPU) 1001, a read only memory (ROM) 1002, and a random access memory (RA) 1003. The CPU 1001, the ROM 1002, and the RAM 1003 form what is called a computer.

Additionally, the information processing apparatus 1 may include an auxiliary storage device 1004, a display device 1005, an operation device 1006, an interface (I/F) device 1007, and a drive device 1008. The hardware components of the information processing apparatus 1 are connected to each other through a bus B.

The CPU 1001 is an arithmetic device that executes various programs installed in the auxiliary storage device 1004.

The ROM 1002 is a non-volatile memory. The ROM 1002 functions as a main storage device that stores various programs and data necessary for the CPU 1001 executing various programs installed in the auxiliary storage device 1004. Specifically, the ROM 1002 functions as a main storage device that stores a boot program, such as a basic input/output system (BIOS) and an extensible firmware interface (EFI).

The RAM 1003 is a volatile memory, such as a dynamic random access memory (DRAM) or a static random access memory (SRAM). The RAM 1003 functions as a main storage device that provides a workspace deployed when various programs installed in the auxiliary storage device 1004 are executed by the CPU 1001.

The auxiliary storage device 1004 is an auxiliary storage device that stores various programs and information used when various programs are executed.

The display device 1005 is a display device that displays an internal state and the like of the information processing apparatus 1.

The operation device 1006 is an input device used by an administrator of the information processing apparatus 1 to input various instructions to the information processing apparatus 1.

The I/F device 1007 is a communication device that connects to a network to communicate with another device.

The drive device 1008 is a device for setting a storage medium 1009. The storage medium 1009 herein includes a medium that optically, electrically, or magnetically records information, such as a CD-ROM, a flexible disk, or a magneto-optical disk. The storage medium 1009 may also include a semiconductor memory or the like that electrically records information, such as an erasable programmable read only memory (EPROM), a flash memory, or the like.

Here, various programs installed in the auxiliary storage device 1004 are installed, for example, by various programs recorded in the storage medium 1009 being read by the drive device 1008 when the distributed storage medium 1009 is set in the drive device 1008. Alternatively, various programs installed in the auxiliary storage device 1004 may be installed by being downloaded from the network through the I/F device 1007.

While the embodiment of the present disclosure has been described in detail above, the present disclosure is not limited to the specific embodiment described above, and various modifications and variations can be made within the scope of the subject matter of the present invention as claimed.

What is claimed is:

1. A method for execution by an information processing apparatus, the method comprising calculating a reciprocal in multiplication on a residue field modulo a power of 2.

2. The method as claimed in claim 1,
wherein the calculating of the reciprocal includes selecting, when a value b is a reciprocal of a value a, whether a multiplication value is added, the multiplication value being obtained by multiplying the value a with a power of 2, and the value a and the value b being odd numbers, and
wherein the value b is a bit sequence, a bit of the bit sequence being set to 1 when the multiplication value is added and being set to 0 when the multiplication value is not added.

3. The method as claimed in claim 1,
wherein the calculating of the reciprocal includes calculating, when a value b is a reciprocal of a value a and a value m is a product of the value a and the value b, the reciprocal by using a plurality of arrays for each of the value a, the value b, and the value m.

4. The method as claimed in claim 1, wherein the calculating of the reciprocal includes calculating the reciprocal in an advanced encryption standard (AES) of the white-box cryptography.

5. An information processing apparatus comprising a processor configured to calculate a reciprocal in multiplication on a residue field modulo a power of 2.

6. A non-transitory computer-readable recording medium having stored therein a program for causing an information processing apparatus to execute a process comprising calculating a reciprocal in multiplication on a residue field modulo a power of 2.
